(19) United States
(12) Patent Application Publication
(10) Pub. No.: US 2023/0222071 A1
(43) Pub. Date: Jul. 13, 2023

(54) CONTROL DEVICE AND ELECTRONIC CONTROL DEVICE

(71) Applicant: LAPIS Technology Co., Ltd., Yokohama (JP)

(72) Inventor: Hiroji Akahori, Yokohama (JP)

(73) Assignee: LAPIS Technology Co., Ltd., Yokohama (JP)

(21) Appl. No.: 18/152,104

(22) Filed: Jan. 9, 2023

(30) Foreign Application Priority Data
Jan. 12, 2022 (JP) 2022-003165

(51) Int. Cl. G06F 13/12

(52) U.S. Cl. CPC G06F 13/126

(57) ABSTRACT

A control device and an electronic control device are provided. The control device according to the disclosure includes a CPU bus, first to Nth (N is an integer equal to or greater than 2) peripheral devices, respectively operating in accordance with an address sent out from a CPU or respectively operating in a case of receiving respectively corresponding first to Nth operation start signals, a memory that stores sequence information indicating a procedure of operating the first to Nth peripheral devices, and a sequencer circuit that supplies the first to Nth operation start signals to the corresponding peripheral devices in order according to the sequence information when the CPU is abnormal or a load amount of the CPU exceeds a predetermined threshold.

### CROSS-REFERENCE TO RELATED APPLICATION

This application claims the priority benefit of Japan application serial no. 2022-003165, filed on Jan. 12, 2022. The entirety of the above-mentioned patent application is hereby incorporated by reference herein and made a part of this specification.

### BACKGROUND

### Technical Field

The disclosure relates to a control device and an electronic control device. In particular, the disclosure relates to an electronic control device including a control component such as a microcomputer and its peripheral devices.

### Related Art

In recent years, electronic control of electrical components of vehicles has been implemented to ensure safe traveling of vehicles, comfortable interior spaces, and traveling assistance. In this case, for example, each device is provided with an electronic control unit (ECU) which is a dedicated microcomputer for controlling devices such as an air conditioner, an engine, a transmission, a brake, and a traveling assistance device of a vehicle.

In addition, with electronic control of vehicles, an electronic control device provided with a monitoring circuit that monitors whether an abnormality (failure) has occurred in the operation of a microcomputer and a device to be controlled has been proposed (see, for example, Patent Document 1: Japanese Patent Application Laid-Open (JP-A) No. 2016-38620).

In the electronic control device, a clear signal (WDC signal) for a watchdog timer used in a microcomputer is supplied to the monitoring circuit, and the monitoring circuit detects whether the period of WDC has fluctuated, thereby monitoring whether an abnormality has occurred in the microcomputer and a control target device.

A microcomputer (hereinafter referred to as an MC) basically has a configuration in which a ROM, a RAM, and the like having programs stored therein together with a central processing unit (CPU) are connected to a CPU bus. Further, MCs in which peripheral devices serving as hardware such as a timer, an analog to digital (AD) converter, and a DA converter are connected to the CPU bus in correspondence with devices to be controlled have been commercialized.

Incidentally, although the electronic control device disclosed in Patent Document 1 can detect its own abnormality, it cannot then control the above-described peripheral devices normally in a case where this abnormality is not resolved. In addition, in a case where the load due to program processing executed by the CPU becomes heavy, it is difficult to access the peripheral device during that time. Thus, such a situation occurring in the electronic control device disclosed in Patent Document 1 interferes with the operation of the control target device.

### SUMMARY

According to an embodiment of the disclosure, there is provided a control device comprising: a CPU bus; first to Nth (N is an integer equal to or greater than 2) peripheral devices, respectively operating in accordance with an address supplied from the CPU bus or respectively operating in a case of receiving respectively corresponding first to Nth operation start signals; a memory that stores sequence information indicating a procedure of operating the first to Nth peripheral devices one by one in order; and a sequencer circuit that is started up in response to a sequencer startup command supplied from the CPU bus to supply the first to Nth operation start signals to the corresponding peripheral devices one by one in order according to the sequence information.

In addition, according to an embodiment of the disclosure, there is provided an electronic control device comprising: a control component including a CPU bus, first to Nth (N is an integer equal to or greater than 2) peripheral devices, respectively operating in accordance with an address supplied from the CPU bus or respectively operating in a case of receiving respectively corresponding first to Nth operation start signals, a memory that stores sequence information indicating a procedure of operating the first to Nth peripheral devices one by one in order, and a sequencer circuit that is started up in response to a sequencer startup command supplied from the CPU bus to supply the first to Nth operation start signals to the corresponding peripheral devices one by one in order according to the sequence information; and a control target device to be controlled by the control component, wherein the control component includes a port switching circuit that supplies a signal output from at least one of the first to Nth peripheral devices to the control target device or supplies a signal output from the control target device to one of the first to Nth peripheral devices.

According to the control device and the electronic control device of the disclosure, in a case where a CPU abnormality or an increase in a CPU load amount occurs while the CPU is controlling the peripheral devices, the sequencer circuit controls the peripheral devices instead of the CPU.

Thus, according to the disclosure, it is possible to reduce the load on the CPU, and to allow the control target device to continue a basic operation without interference even when the CPU is abnormal.

### BRIEF DESCRIPTION OF THE DRAWINGS

FIG. 1 is a block diagram illustrating a configuration of an electronic control device 100 which is a first example according to the disclosure.

FIG. 2 is a block diagram illustrating a basic configuration of each peripheral device.

FIG. 3 is a flowchart illustrating a procedure of an operation state monitoring process.

FIG. 4 is a time chart illustrating an example of sequence control for peripheral devices.

FIG. 5 is a block diagram illustrating a configuration of an electronic control device 200 which is a second example according to the disclosure.

### DETAILED DESCRIPTION

The embodiments of the disclosure provide a control device and an electronic control device capable of reducing the load on a CPU and continuing a basic operation without interference even when an operation of the CPU is abnormal.

Hereinafter, examples of the disclosure will be described in detail with reference to the accompanying drawings.

### Example 1

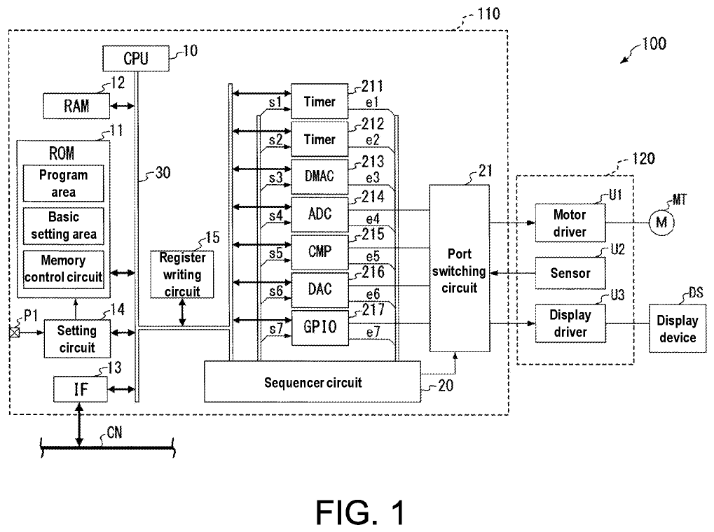

FIG. 1 is a block diagram illustrating a configuration of an electronic control device 100 which is a first example according to the disclosure.

The electronic control device 100 includes a microcomputer 110 (hereinafter referred to as an MCU 110) serving as a control component (control device) and a control target device 120 to be controlled by the MCU 110. The electronic control device 100 is provided for controlling, for example, each electrical component of a vehicle, and is connected to an in-vehicle network CN such as a controller area network (CAN) or a local interconnect network (LIN).

The control target device 120 is, for example, a motor driver U1, a sensor U2, and a display driver U3 which are included in one of a plurality of electrical components mounted in the vehicle. The motor driver U1 receives a motor control signal through a port switching circuit 21 and supplies a motor drive voltage corresponding to the motor control signal to a motor MT. The motor MT rotates its own rotor in accordance with the motor drive voltage. The sensor U2 detects physical and chemical phenomena such as ambient temperature, acceleration, or pressure, and supplies the port switching circuit 21 with a sensor signal obtained by converting the detected amount into an electrical signal. The display driver U3 receives a display control signal through the port switching circuit 21 and supplies a display drive voltage corresponding to the display control signal to a display device DS serving as a load. The display device DS performs image display or light emission (including blinking) based on the display drive voltage.

The MCU 110 includes a central processing unit (CPU) 10, a read only memory (ROM) 11, a random access memory (RAM) 12, an interface unit (IF) 13, a setting circuit 14, a register writing circuit 15, a sequencer circuit 20, the port switching circuit 21, and peripheral devices to be described later.

The peripheral devices are, for example, two systems of timers 211 and 212, a direct memory access (DMA) circuit 213, an analog to digital (AD) converter 214, a comparison circuit (CMP) 215, a digital to analog (DA) converter 216, and a general purpose input output (GPIO) control circuit 217.

The CPU 10, the ROM 11, the RAM 12, the interface unit 13, the setting circuit 14, the register writing circuit 15, the sequencer circuit 20, the port switching circuit 21, and the peripheral devices (211 to 217) are connected to a CPU bus 30. Meanwhile, the interface unit 13 is connected to the in-vehicle network CN, and fetches update information relating to program information stored in a program area or various types of information necessary to operate the control target device 120 to the CPU bus 30 through the in-vehicle network CN. In addition, the interface unit 13 fetches information indicating the operating state of the electronic control device 100 or the like read out from the RAM 12 through the CPU bus 30 and sends it out to the in-vehicle network CN.

The ROM 11 includes a program area and a basic setting area serving as data storage areas, and a memory control circuit.

The program area stores in advance program information for operating the control target device 120 to be executed by the CPU 10.

The basic setting area stores basic setting information for setting each of the peripheral devices (211 to 217) to operate in a predetermined basic operation together with sequence information indicating a procedure of operating the sequencer circuit 20. Meanwhile, the basic setting information is information indicating basic setting data corresponding to each peripheral device in association with each address allocated to each peripheral device.

The memory control circuit performs writing and readout access for the program area and the basic setting area.

Here, the sequence information and the basic setting information to be stored in the basic setting area can be written or rewritten to the basic setting area only when they are provided from the outside through an external port P1. The external port P1 is used only in the manufacturing stage or inspection stage before shipment from the factory.

In a case where it is detected that the sequence information and the basic setting information have been received through the external port P1, the setting circuit 14 supplies identification information indicating that the sequence information and the basic setting information are transmitted through the external port P1, the sequence information, and the basic setting information to the memory control circuit. At this time, the memory control circuit writes the sequence information and the basic setting information to the basic setting area only in a case where the identification information is transmitted through the external port P1. This prevents the content of the basic setting area from being rewritten with unauthorized information data provided through the in-vehicle network CN after shipment from the factory. Meanwhile, although the memory control circuit determines whether a route of acquisition of the sequence information and the basic setting information is the external port P1 on the basis of the identification information described above, the route of acquisition may be detected using other methods.

The CPU 10 executes program information read out from the program area of the ROM 11 and written to the RAM 12 through the CPU bus 30 in response to power-up. The CPU 10 sends out an address indicating an operation execution command for causing each of the timers 211 and 212, the DMA circuit 213, the AD converter 214, the comparison circuit 215, the DA converter 216, and the GPIO control circuit 217 serving as peripheral devices to execute an operation to the CPU bus 30 in accordance with the program information.

Thereby, each of the timers 211 and 212 starts to clock time, and sends out time information indicating the clocked time to the CPU bus 30. In addition, the timer 211 (212) outputs an end signal e1 (e2) at a timing when the time information is output initially after the start of clocking time. Meanwhile, the timer 211 (212) also starts to clock time as described above in a case where an operation start signal s1 (s2) is supplied from the sequencer circuit 20.

The DMA circuit 213 performs writing or readout access for the RAM 12 or the ROM 11 without going through the CPU 10. In addition, the DMA circuit 213 outputs an end signal e3 each time one memory access is completed. Meanwhile, the DMA circuit 213 also executes the memory access described above in a case where an operation start signal s3 is supplied from the sequencer circuit 20.

The AD converter 214 converts, for example, an analog sensor signal received through the port switching circuit 21 into a digital value (AD conversion process), and sends out sensor data indicating the digital value to the CPU bus 30. In addition, the AD converter 214 outputs an end signal e4 each time one AD conversion process is completed. Meanwhile, the AD converter 214 also executes the AD conversion process described above in a case where an operation start signal s4 is supplied from the sequencer circuit 20.

The comparison circuit 215 compares, for example, a predetermined threshold supplied through the CPU bus 30 with the magnitude of a sensor signal received through the port switching circuit, and sends out comparison result data indicating the comparison result to the CPU bus 30. In addition, the comparison circuit 215 outputs an end signal e5 each time one comparison process is completed. Meanwhile, the comparison circuit 215 also executes the comparison process described above in a case where an operation start signal s5 is supplied from the sequencer circuit 20.

The DA converter 216 converts, for example, control data for motor control or display control received through the CPU bus 30 into a motor control signal or a display control signal having an analog voltage value (DA conversion process), and supplies the motor control signal or the display control signal to the port switching circuit 21. In addition, the DA converter 216 outputs an end signal e6 each time one DA conversion process is completed. Meanwhile, the DA converter 216 also executes the DA conversion process described above in a case where an operation start signal s6 is supplied from the sequencer circuit 20.

The GPIO control circuit 217 controls the states (input or output) of three external ports and the connection state between each external port and each of the peripheral devices (214 to 217) for the port switching circuit 21 on the basis of port setting data received through the CPU bus 30. In addition, the GPIO control circuit 217 outputs an end signal e7 when port connection control for the port switching circuit 21 based on the port setting data received through the CPU bus 30 is completed. Meanwhile, the GPIO control circuit 217 also executes the port connection control described above in a case where an operation start signal s7 is supplied from the sequencer circuit 20.

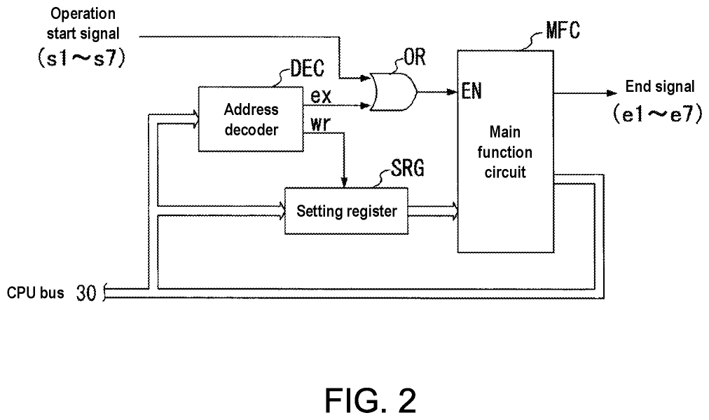

FIG. 2 is a block diagram illustrating a basic configuration of each of the timers 211 and 212, the DMA circuit 213, the AD converter 214, the comparison circuit 215, the DA converter 216, and the GPIO control circuit 217 serving as peripheral devices.

As shown in FIG. 2, each of the peripheral devices (211 to 217) includes a main function circuit MFC that realizes its main function, an address decoder DEC, a setting register SRG, and an OR gate OR.

The address decoder DEC supplies a writing signal wr to the setting register SRG in a case where an address indicating a register setting command corresponding to this peripheral device is received through the CPU bus 30. Here, the setting register SRG holds the basic setting data continuously received through the CPU bus 30 in response to the writing signal wr, and supplies it to the main function circuit MFC.

In addition, the address decoder DEC supplies an operation execution signal ex to the OR gate OR in a case where an address indicating an operation execution command corresponding to this peripheral device is received through the CPU bus 30. The OR gate OR supplies an enable signal for executing an operation to the main function circuit MFC in a case where the operation execution signal ex or an operation start signal (s1 to s7) is received from the sequencer circuit 20. The main function circuit MFC enters an operating state in response to the enable signal, executes an operation for performing its main function (for example, the AD conversion process if this peripheral device is the AD converter 214), and sends out the operation result (for example, sensor data) to the CPU bus 30.

Meanwhile, the main function circuit MFC outputs an end signal (e1 to e7) at a timing when an operation result is output initially in response to an address indicating an operation execution command through the CPU bus 30 or an operation start signal (s1 to s7) from the sequencer circuit 20. The end signal is supplied to the sequencer circuit 20 and is also supplied to the CPU 10 as an interruption signal.

The port switching circuit 21 receives the port connection control performed by the GPIO control circuit 217, and supplies, for example, a motor control signal having an analog voltage value output from the DA converter 216 serving as a peripheral device to the motor driver U1 serving as a control target device. In addition, the port switching circuit 21 receives the port connection control and supplies, for example, a display control signal having an analog voltage value output from the DA converter 216 serving as a peripheral device to the display driver U3 serving as a control target device. In addition, the port switching circuit 21 receives the port connection control and supplies a sensor signal output from the sensor U2 serving as a control target device to the AD converter 214 serving as a peripheral device.

That is, the port switching circuit 21 receives the port connection control to supply a signal output from at least one of a plurality of peripheral devices (211 to 217) to one control target device or supply a signal output from the control target device to one of the peripheral devices.

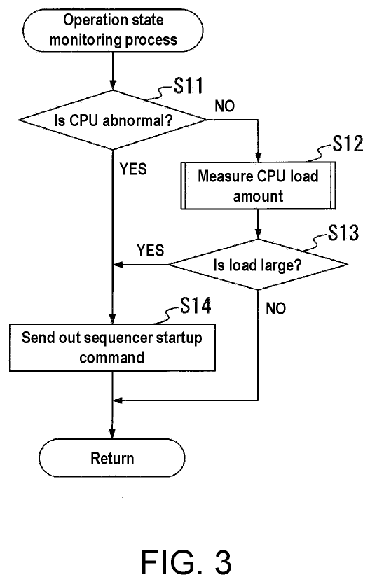

The CPU 10 executes the operation state monitoring process shown in FIG. 3 for each predetermined period during execution of main control according to the program information stored in the program area of the ROM 11.

In FIG. 3, the CPU 10 first determines whether an abnormality, that is, a CPU abnormality has occurred in the operation of itself (the CPU 10), for example, due to an interruption from a watchdog timer (not shown) or the like (step S11).

In a case where it is determined in step S11 that there is no abnormality, the CPU 10 measures the usage rate of itself (the CPU 10) during execution of program processing as a CPU load amount (step S12). The CPU 10 then determines whether the measured CPU load amount is greater than a predetermined threshold (step S13).

In a case where it is determined in step S13 that the CPU load amount is greater than the predetermined threshold, or a case where it is determined in step S11 that there is an abnormality, the CPU 10 sends out an address indicating a sequencer startup command to the CPU bus 30 (step S14). After execution of step S14, or in a case where it is determined in step S13 that the CPU load amount is equal to or less than the predetermined threshold, the CPU 10 returns to execution of main control according to the program information.

Here, the register writing circuit 15 and the sequencer circuit 20 that have received the address indicating the sequencer startup command through the CPU bus 30 perform the following operations.

The register writing circuit 15 first reads out the sequence information and the basic setting information stored in the basic setting area of the ROM 11 and fetches them through the CPU bus 30.

Next, the register writing circuit 15 sends out an address indicating a register setting command corresponding to each peripheral device and basic setting data which are indicated by the fetched basic setting information to the CPU bus 30. Thereby, the setting register SRG of each of the timers 211 and 212, the DMA circuit 213, the AD converter 214, the comparison circuit 215, the DA converter 216, and the GPIO control circuit 217 stores each corresponding basic setting data. Thus, each of the timers 211 and 212, the DMA circuit 213, the AD converter 214, the comparison circuit 215, the DA converter 216, and the GPIO control circuit 217 is set to perform a basic operation indicated by each corresponding basic setting data.

The register writing circuit 15 then supplies the fetched sequence information to the sequencer circuit 20 through the CPU bus 30.

The sequencer circuit 20 holds the sequence information in a built-in register. In response to the sequencer startup command, the sequencer circuit 20 executes sequence control for sequentially operating the timers 211 and 212, the DMA circuit 213, the AD converter 214, the comparison circuit 215, the DA converter 216, and the GPIO control circuit 217 in a procedure according to this sequence information. Further, the sequencer circuit 20 controls the port switching circuit 21 directly or through the GPIO control circuit 217 in a procedure according to the sequence information.

Meanwhile, the sequence information is in line with, for example, the program information stored in the program area of the ROM 11. In this case, the sequence information may be program information which is simplified to such an extent that it does not interfere with the operation of the motor MT and the display device DS connected to the control target device 120. In addition, the sequence information may be different from the program information stored in the program area, for example, controlled to forcibly limit the number of rotations of the motor MT to a predetermined number of rotations and to cause the display device DS to forcibly display an abnormality notification.

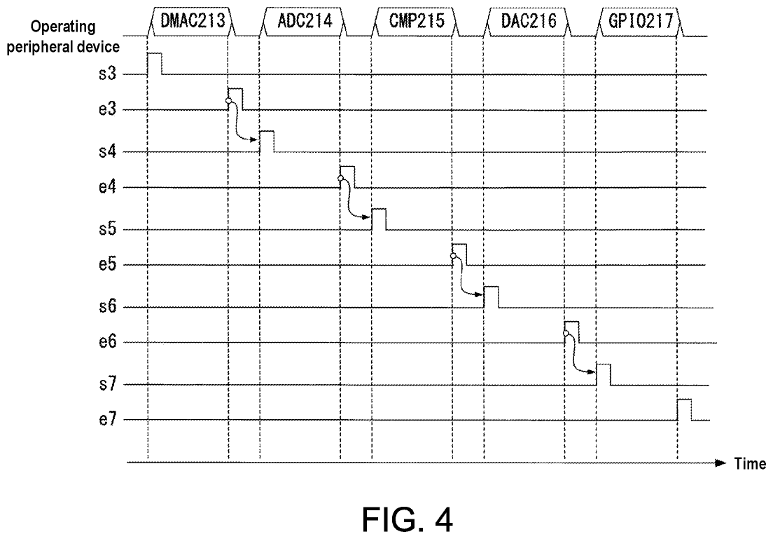

Hereinafter, sequence control performed by the sequencer circuit 20 will be described with reference to an example shown in FIG. 4.

Meanwhile, FIG. 4 is a time chart of sequence control executed by the sequencer circuit 20 in a case where the sequence information indicates that the peripheral devices are to be operated in the order of the DMA circuit 213, the AD converter 214, the comparison circuit 215, the DA converter 216, and the GPIO control circuit 217.

As shown in FIG. 4, the sequencer circuit 20 first supplies the operation start signal s3 to the DMA circuit 213. The DMA circuit 213 accesses the RAM 12 or the ROM 11 for writing or readout in response to the operation start signal s3. The DMA circuit 213 then outputs the end signal e3 when this memory access is completed.

The sequencer circuit 20 supplies the operation start signal s4 to the AD converter 214 to be operated next in response to the end signal e3. The AD converter 214 performs the AD conversion process on the analog signal supplied from the port switching circuit 21 in response to the operation start signal s4. The AD converter 214 then outputs the end signal e4 when this AD conversion process is completed.

The sequencer circuit 20 supplies the operation start signal s5 to the comparison circuit 215 to be operated next in response to the end signal e4. The comparison circuit 215 performs the comparison process of comparing a predetermined threshold with the magnitude of a signal received through the port switching circuit 21 in response to the operation start signal s5. The comparison circuit 215 then outputs the end signal e5 when this comparison process is completed.

The sequencer circuit 20 supplies the operation start signal s6 to the DA converter 216 to be operated next in response to the end signal e5. The DA converter 216 performs the DA conversion process of converting digital data received through the CPU bus 30 into an analog voltage value in response to the operation start signal s6. The DA converter 216 then outputs the end signal e6 when this DA conversion process is completed.

The sequencer circuit 20 supplies the operation start signal s7 to the GPIO control circuit 217 to be operated next in response to the end signal e6. The GPIO control circuit 217 controls the state (input or output) of three external ports and the state of connection between each external port and each of the peripheral devices (214 to 217) for the port switching circuit 21 on the basis of the port setting data received through the CPU bus 30 in response to operation start signal s7. The GPIO control circuit 217 then outputs the end signal e7 when this port connection control is completed.

The sequencer circuit 20 supplies the signal to any one of the peripheral devices (211 to 217) to be operated next in response to the end signal e6, and performs the above-described control process.

In short, the sequencer circuit 20 supplies one peripheral device according to the sequence information with the operation start signal corresponding to the one peripheral device, and when an end signal is output from the one peripheral device, the sequencer circuit supplies a peripheral device next to the one peripheral device indicated by the sequence information with the operation start signal corresponding to the next peripheral device.

Meanwhile, in an example shown in FIG. 4, the sequencer circuit 20 operates the peripheral devices in the order of the DMA circuit 213, the AD converter 214, the comparison circuit 215, the DA converter 216, and the GPIO control circuit 217. However, the sequencer circuit 20 may change a peripheral device to be operated next from the DA converter 216 to the AD converter 214 on the basis of the comparison result of the comparison circuit 215.

As described above, in the MCU 110, in a case where the load of the CPU 10 increases or a case where an abnormality occurs in the CPU 10, the sequencer circuit 20 performs sequence control on the peripheral devices (211 to 217) instead of the CPU 10 to thereby continue a basic operation.

Thus, according to the disclosure, it is possible to reduce the load on the CPU, and to continue a basic operation without interference even when program processing performed by the CPU is abnormal.

Meanwhile, in the example shown in FIG. 1, a total of seven peripheral devices, that is, the timers 211 and 212, the DMA circuit 213, the AD converter 214, the comparison circuit 215, the DA converter 216, and the GPIO control circuit 217, are controlled by the CPU 10. However, the number of peripheral devices controlled by the CPU 10 is not limited to seven.

In addition, in the above example, in a case where the load on the CPU 10 increases or a case where an abnormality occurs in the CPU 10, the sequencer circuit 20 controls the peripheral devices (211 to 217) instead of the CPU 10, but the sequencer circuit 20 may always control the peripheral devices regardless of the state of the CPU 10.

In short, the electronic control device 100 need only include the following first to Nth (N is an integer equal to or greater than 2) peripheral devices, a memory, and a sequencer circuit together with the CPU 10.

The first to Nth peripheral devices (211 to 217) respectively operate in accordance with an address sent out from the CPU (10) or respectively operate in a case of receiving respectively corresponding first to Nth operation start signals. The memory (11) stores sequence information indicating a procedure of operating the first to Nth peripheral devices one by one in order. The sequencer circuit (20) is started up in response to the sequencer startup command supplied from the CPU bus (30), and supplies the first to Nth operation start signals (s1 to s7) to the corresponding peripheral device one by one in order according to the sequence information.

### Example 2

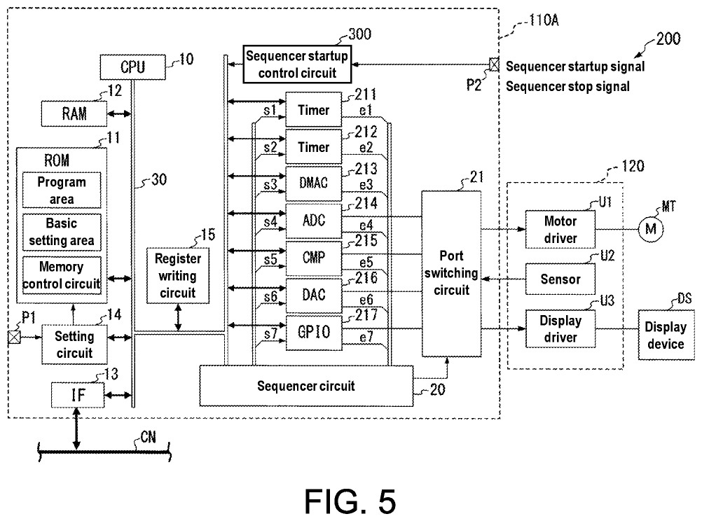

FIG. 5 is a block diagram illustrating a configuration of an electronic control device 200 which is a second example according to the disclosure.

In the electronic control device 200 FIG. 5, an MCU 110A is adopted instead of the MCU 110.

Meanwhile, the MCU 110A has the same configuration as that of the MCU 110 shown in FIG. 1, except that an external port P2 and a sequencer startup control circuit 300 are newly provided so that the sequencer circuit 20 can be started up and stopped directly from the outside.

The external port P2 receives a sequencer startup signal or a sequencer stop signal from the outside. In a case where the sequencer startup signal is received through the external port P2, the sequencer startup control circuit 300 supplies a sequencer startup command to the register writing circuit 15 and the sequencer circuit 20 through the CPU bus 30. Thereby, similarly to the MCU 110, sequence control starts on the peripheral devices (211 to 217) in a procedure according to the sequence information stored in the basic setting area of the ROM 11. In addition, in a case where the sequencer stop signal is received through the external port P2, the sequencer startup control circuit 300 supplies a sequencer stop command for forcibly stopping a sequence control operation performed by the sequencer circuit 20 to the sequencer circuit 20 through the CPU bus 30.

In this way, according to the electronic control device 200, it is possible to forcibly start up the sequencer circuit 20 using an external command regardless of the operating state of the CPU 10.

What is claimed is:

1. A control device comprising:
a CPU bus;
first to Nth peripheral devices, respectively operating in accordance with an address supplied from the CPU bus or respectively operating in a case of receiving respectively corresponding first to Nth operation start signals, N being an integer equal to or greater than 2;
a memory that stores sequence information indicating a procedure of operating the first to Nth peripheral devices one by one in order; and
a sequencer circuit that is started up in response to a sequencer startup command supplied from the CPU bus to supply the first to Nth operation start signals to the corresponding peripheral devices one by one in order according to the sequence information.

2. The control device according to claim 1, wherein the peripheral device outputs an end signal at a timing when an operation result according to the operation start signal is output, and
the sequencer circuit supplies one peripheral device according to the sequence information among the first to Nth peripheral devices with the operation start signal corresponding to the one peripheral device, and when the end signal is output from the one peripheral device, the sequencer circuit supplies a peripheral device next to the one peripheral device indicated by the sequence information with the operation start signal corresponding to the next peripheral device.

3. The control device according to claim 1, wherein the memory stores basic setting information for individually setting each of the first to Nth peripheral devices to operate in a predetermined basic operation, and
the control device further comprises a register writing circuit that reads out the basic setting information from the memory in response to the sequencer startup command and writes the respectively corresponding basic setting information to a setting register built into each of the first to Nth peripheral devices.

4. The control device according to claim 2, wherein the memory stores basic setting information for individually setting each of the first to Nth peripheral devices to operate in a predetermined basic operation, and
the control device further comprises a register writing circuit that reads out the basic setting information from the memory in response to the sequencer startup command and writes the respectively corresponding basic setting information to a setting register built into each of the first to Nth peripheral devices.

5. The control device according to claim 1, wherein a CPU connected to the CPU bus sends out the sequencer startup command to the CPU bus when the CPU is abnormal or a load amount exceeds a predetermined threshold.

6. The control device according to claim 2, wherein a CPU connected to the CPU bus sends out the sequencer startup command to the CPU bus when the CPU is abnormal or a load amount exceeds a predetermined threshold.

7. The control device according to claim 3, wherein a CPU connected to the CPU bus sends out the sequencer startup command to the CPU bus when the CPU is abnormal or a load amount exceeds a predetermined threshold.

8. The control device according to claim 1, further comprising:
an external port that receives a startup signal for starting up the sequencer circuit or a stop signal for stopping an operation of the sequencer circuit; and
a sequencer startup control circuit that performs control for starting up the sequencer circuit in a case where the external port receives the startup signal and stopping the operation of the sequencer circuit in a case where the external port receives the stop signal.

9. The control device according to claim 2, further comprising:
an external port that receives a startup signal for starting up the sequencer circuit or a stop signal for stopping an operation of the sequencer circuit; and
a sequencer startup control circuit that performs control for starting up the sequencer circuit in a case where the external port receives the startup signal and stopping the operation of the sequencer circuit in a case where the external port receives the stop signal.

10. The control device according to claim 3, further comprising:
an external port that receives a startup signal for starting up the sequencer circuit or a stop signal for stopping an operation of the sequencer circuit; and
a sequencer startup control circuit that performs control for starting up the sequencer circuit in a case where the external port receives the startup signal and stopping the operation of the sequencer circuit in a case where the external port receives the stop signal.

11. The control device according to claim 5, further comprising:
an external port that receives a startup signal for starting up the sequencer circuit or a stop signal for stopping an operation of the sequencer circuit; and
a sequencer startup control circuit that performs control for starting up the sequencer circuit in a case where the external port receives the startup signal and stopping the operation of the sequencer circuit in a case where the external port receives the stop signal.

12. An electronic control device comprising:
a control component including
a CPU bus,
first to Nth peripheral devices, respectively operating in accordance with an address supplied from the CPU bus or respectively operating in a case of receiving respectively corresponding first to Nth operation start signals, N being an integer equal to or greater than 2,
a memory that stores sequence information indicating a procedure of operating the first to Nth peripheral devices one by one in order, and
a sequencer circuit that is started up in response to a sequencer startup command supplied from the CPU bus to supply the first to Nth operation start signals to the corresponding peripheral devices one by one in order according to the sequence information; and
a control target device to be controlled by the control component,
wherein the control component includes a port switching circuit that supplies a signal output from at least one of the first to Nth peripheral devices to the control target device or supplies a signal output from the control target device to one of the first to Nth peripheral devices.
